(19) United States
(12) Patent Application Publication
(10) Pub. No.: US 2023/0334330 A1
(43) Pub. Date: Oct. 19, 2023

(54) AUTOMATED CREATION OF TINY DEEP LEARNING MODELS BASED ON MULTI-OBJECTIVE REWARD FUNCTION

(71) Applicant: Tata Consultancy Services Limited, Mumbai (IN)

(72) Inventors: SHALINIA MUKHOPADHYAY, Kolkata (IN); RAJIB LOCHAN C JANA, Kolkata (IN); AVIK GHOSE, Kolkata (IN); SWARNAVA DEY, Kolkata (IN); JEET DUTTA, Kolkata (IN)

(73) Assignee: Tata Consultancy Services Limited, Mumbai (IN)

(21) Appl. No.: 18/177,601

(22) Filed: Mar. 2, 2023

(30) Foreign Application Priority Data
Apr. 13, 2022 (IN) 202221022177

(51) Int. Cl. G06N 3/092; G06N 3/086

(52) U.S. Cl. CPC G06N 3/092; G06N 3/086

(57) ABSTRACT

State of art techniques existing method refer to handling multiple objectives such as accuracy and latency. However, the reward functions are static and not tunable at user end. Further, for NN search with hardware constraints, approaches combine various techniques such as Reinforcement learning, Evolutionary Algorithm (EA) etc., however hardly any work attempts to disclose combining different NAS approaches in unison to reduce the search space of other. Embodiments of the present disclosure provide a method and system for automated creation of tiny Deep Learning (DL) models to be deployed on a platform having a set of hardware constraints. The method performs a coarse-grained search using a Fast EA NAS model and then utilizes a fine-grained search to identify customized and optimized tiny model. The coarse-grained search and the fine-grained search performed by agents based on a weighted multi-objective reward function, which are tunable at user end.

### PRIORITY CLAIM

This U.S. patent application claims priority under 35 U.S.C. § 119 to: Indian Patent Application No. 202221022177, filed on Apr. 13, 2022. The entire contents of the aforementioned application are incorporated herein by reference.

### TECHNICAL FIELD

The embodiments herein generally relate to Machine Learning (ML) and, more particularly, to a method and system for automated creation of tiny Deep Learning (DL) models based on a multi-objective reward function.

### BACKGROUND

Edge computing is an emerging domain of computing and Artificial Intelligence (AI) which deals with running Machine Learning (ML) and especially Deep Learning (DL) models on embedded devices. However, embedded devices are resource constraint and therefore, the models need to be reengineered to be deployed on such platforms. Several techniques like Neural Architecture Search (NAS) and model compression, which are employed to compress and generate optimized models for a particular hardware of the edge device or platform. While compression employs techniques like quantization, pruning and layer fusing to achieve smaller networks, NAS is a much tougher problem of selecting a network from given set of templates based on both hardware constraints and features. However, since space of embedded platforms is heterogeneous, the Neural Network (NN) search to get optimized model is huge with search approaches for NAS. Evolutionary Algorithms (EAs), Reinforcement Learning (RL), differentiable NAS etc., can solve the NAS search problem through agent based systems and hit-and-trial runs. However, even with RL in place, the best outcomes are not guaranteed because of the nature of RL exploration and exploitation as outlined by works in literature. Some existing methods refer to using EA or RL or both, however, do not disclose how multiple techniques work together in unison.

Building Deep Learning models for embedded systems not only requires skills in AI/DL, but also relies on the capability of choosing proper model primitives and network structures that are suitable for resource-limited systems. A search for such architectures must be platform aware, that is along with accuracy, which is generally the maim performance objective, it must conform to other hardware constraints such as inference latency (indicative of number of operations), runtime memory usage and size of the model. Works in the literature have referred to using multi-objective optimization to simultaneously balance objectives such the accuracy, scale, latency etc., when using NAS for hardware constraint target platforms. For example, an existing method ‘Multi-Objective Neural Architecture Search’, by Chi-Hung Hsu et. al generates threshold condition based formulation of multiple rewards that changes depending on condition, However, does not propose multiple reward unction which is not generalized across all objectives. Another example work in literature, ‘Multi-Task Learning for Multi-Objective Evolutionary Neural Architecture Search’ by Ronghong Cai and Jianping Luo et.al uses the multi-objective optimization algorithm to simultaneously balance the performance and the scale and build a multi-objective evolutionary search framework to find the Pareto optimal front. However, the work is uses NSGA-II multi-objective optimization to search for models in the domain of Multi-task learning, wherein it optimizes only for 2 objectives—accuracy and number of parameters (scale) in a network scale. However, it was observed that some deeper networks can have lesser parameters than some smaller networks (33,325,792 for a 16 layered VGG vs 11,164,352 for an 18 layered ResNet) and yet perform better. Hence scale may not be appropriate parameter to be considered for optimization of NN.

### SUMMARY

Embodiments of the present disclosure present technological improvements as solutions to one or more of the above-mentioned technical problems recognized by the inventors in conventional systems.

For example, in one embodiment, a method for automated creation of tiny Deep Learning (DL) models based on a multi-objective reward function is provided. The method includes receiving a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model. Further, the method includes formulating a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics. Further, the method includes creating a Neural Architecture Search (NAS) space (S^{O×C}) comprising of a plurality of operations and configurations of Neural Network (NN) architectures in accordance with the target application. Furthermore, the method includes applying a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R). Furthermore, the method includes performing a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model. A weighted relation of the multi-objective reward function (R) with the accuracy is linear, and the latency, the runtime memory and the size are exponential are added as a combined weighted exponential function of a difference between one or more actual values and one or more target values based on the hardware constraints for each of the latency, the runtime memory, and the size among the plurality of performance metrics.

In another aspect, a system for automated creation of tiny Deep Learning (DL) models based on a multi-objective reward function is provided. The system comprises a memory storing instructions; one or more Input/Output (I/O) interfaces; and one or more hardware processors coupled to the memory via the one or more I/O interfaces, wherein the one or more hardware processors are configured by the instructions to receive a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model. Further, the system formulates a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics. Further, the system creates a Neural Architecture Search (NAS) space (S^{O×C}) comprising of a plurality of operations and configurations of Neural Network (NN) architectures in accordance with the target application. Furthermore, the system applies a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R). Furthermore, the system performs a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model. A weighted relation of the multi-objective reward function (R) with the accuracy is linear, and the latency, the runtime memory and the size are exponential are added as a combined weighted exponential function of a difference between one or more actual values and one or more target values based on the hardware constraints for each of the latency, the runtime memory, and the size among the plurality of performance metrics.

In yet another aspect, there are provided one or more non-transitory machine-readable information storage mediums comprising one or more instructions, which when executed by one or more hardware processors causes a method for automated creation of tiny Deep Learning (DL) models based on a multi-objective reward function. The method includes receiving a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model. Further, the method includes formulating a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics. Further, the method includes creating a Neural Architecture Search (NAS) space (S^{O×C}) comprising of a plurality of operations and configurations of Neural Network (NN) architectures in accordance with the target application. Furthermore, the method includes applying a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R). Furthermore, the method includes performing a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model. A weighted relation of the multi-objective reward function (R) with the accuracy is linear, and the latency, the runtime memory and the size are exponential are added as a combined weighted exponential function of a difference between one or more actual values and one or more target values, based on the hardware constraints for each of the latency, the runtime memory, and the size among the plurality of performance metrics. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system for automated creation of tiny Deep Learning (DL) models based on a multi-objective reward function, in accordance with some embodiments of the present disclosure.

FIG. 1B illustrates an architectural overview of the system of FIG. 1A, in accordance with some embodiments of the present disclosure.

FIGS. 2A and 2B (collectively referred as FIG. 2) is a flow diagram illustrating a method for automated creation of tiny Deep Learning (DL) models based on a multi-objective reward function, using the system of FIG. 1A, in accordance with some embodiments of the present disclosure.

FIG. 3 depicts first experimental results for a Deep Q-Learning Network (DQN) model based Neural Architecture Search (NAS) for creating tiny DL models, in accordance with some embodiments of the present disclosure.

FIG. 4 depicts second experimental results fora Deep Q-Learning Network (DQN) model based Neural Architecture Search (NAS) for creating tiny DL models, in accordance with some embodiments of the present disclosure.

FIG. 5 depicts third experimental results for a Deep Q-Learning Network (DQN) model based Neural Architecture Search (NAS) for creating tiny DL models, in accordance with some embodiments of the present disclosure.

FIG. 6 depicts candidate models that have been searched for with their objectives using an Evolutionary Algorithm based NAS search.

FIG. 7 depict searched models arranged based on performance metrics, selection in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Neural Architecture Search (NAS) based model optimizations for hardware constraint devices is performed using various approaches. Some solutions discuss multiple objective NAS but require formulating multiple reward functions based on objective of interest. Some existing method refer to simultaneously handling multiple objectives such as accuracy and latency. However, the reward functions are static and not dynamically tunable at user end. Further, proposed are approaches that combine various techniques such as Reinforcement learning, Evolutionary Algorithm (EA) etc., however hardly any work attempts to disclose combining different NAS approaches in unison to reduce the search space of other.

Embodiments of the present disclosure provide a method and system for automated creation of tiny Deep Learning (DL) models to be deployed on a platform with hardware constraints. The method performs a coarse-grained search using a Fast EA NAS model with an EA agent utilizing a multi-objective reward function (R). The Fast EA NAS model identifies set of Neural Network (NN) architectures from large NAS space and narrows the search space to provide a refined search space. Further, a fine-grained search is performed on the refined search space by a Deep Q-Learning Network (DQN) model, wherein a DQN agent also utilizes the multi-objective reward function (R) to identify the customized and optimized architecture for the tiny model. The reward function is formulated such that it is a linear function of accuracy and exponential function of other performance metrics, which can be individually modulated, prioritized and thresholded based on relative weightage assigned to each of the performance metric in accordance requirements of a target application Narrowing down the search space of the DQN enables speedy identification of the customized and optimized architecture.

The relative weightage assigned to each of the performance metric is tunable, enabling dynamic changing of the multi-objective reward function (R) without requiring rebuilding and retraining of the Fast Evolutionary Algorithm (EA) NAS model and the DQN NAS model to align to changing requirements of the target application to be executed on of the platform. Thus, the method disclosed provides robustness across hardware platforms of different specifications, wherein user can input the details and the tiny models are generated accordingly.

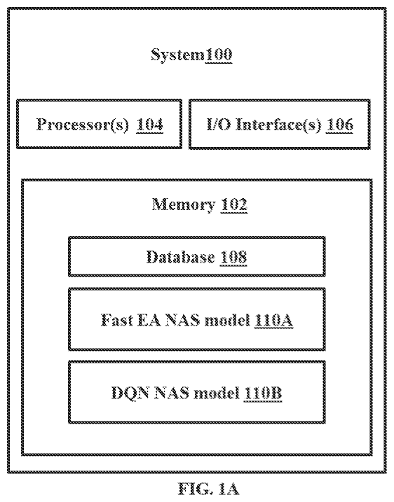

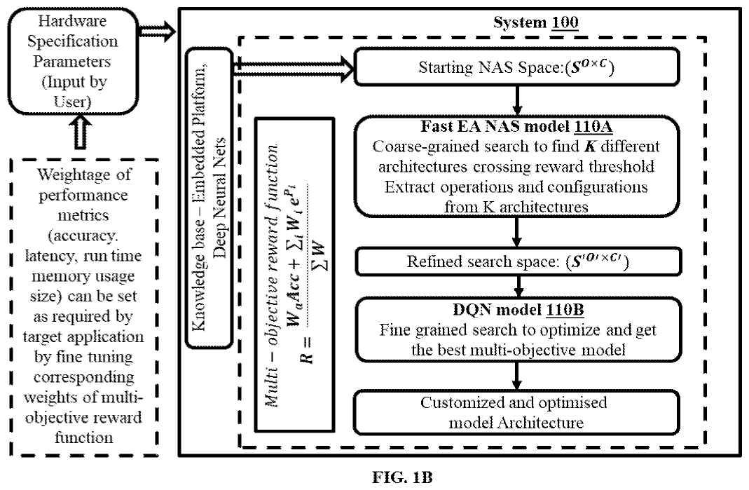

Referring now to the drawings, and more particularly to FIGS. 1A through 7, where similar reference characters denote corresponding features consistently throughout the figures, there are shown preferred embodiments and these embodiments are described in the context of the following exemplary system and/or method.

FIG. 1A is a functional block diagram of a system 100 for automated creation of tiny Deep Learning (DL) models based on the multi-objective reward function, in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface to display the generated target images and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

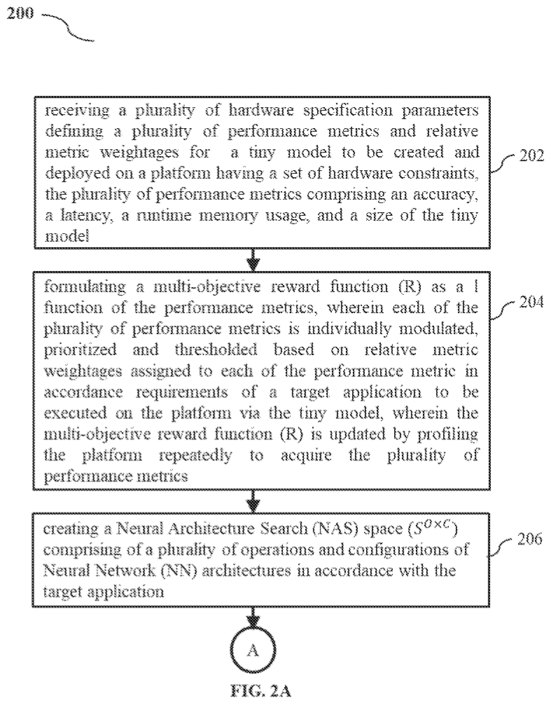

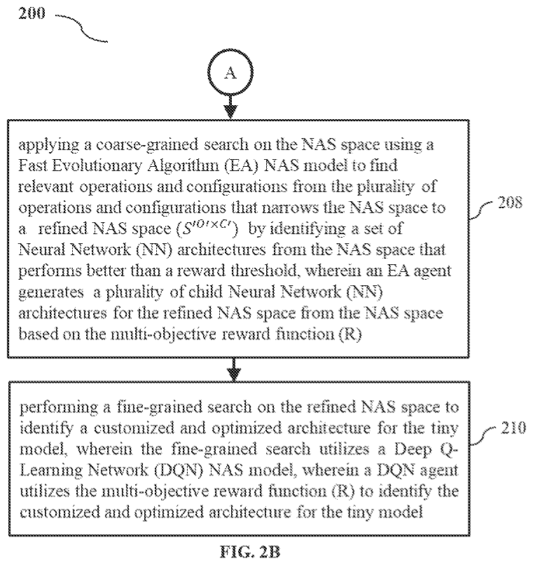

In an embodiment, the memory 102 includes a plurality of modules 110 such as Fast EA NAS model 110A and DQN NAS model 110B explained later in conjunction architecture of the system 100 as depicted in FIG. 1B and flow diagram of the method executed by the system 100 for creating tiny models as depicted in FIG. 2. The plurality of modules 110 include programs or coded instructions that supplement applications or functions performed by the system 100 for executing different steps involved in the process of automated creation of tiny Deep Learning (DL) models based on the multi-objective reward function, being performed by the system 100. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 110 can be used by hardware, by computer-readable instructions executed by the one or more hardware processors 104, or by a combination thereof. The plurality of modules 110 can include various sub-modules (not shown). The plurality of modules 110 may include computer-readable instructions that supplement applications or functions performed by the system 100 for automated creation of tiny Deep Learning (DL) models based on a multi-objective reward function. Further, the memory 102 may comprise information pertaining to input(s)/output(s) of each step performed by the processor(s) 104 of the system 100 and methods of the present disclosure.

Further, the memory 102 includes a database 108. The database (or repository) 108 may include a plurality of abstracted piece of code for refinement and data that is processed, received, or generated as a result of the execution of the plurality of modules in the module(s) 110. Although the data base 108 is shown internal to the system 100, it will be noted that, in alternate embodiments, the database 108 can also be implemented external to the system 100, and communicatively coupled to the system 100. The data contained within such external database may be periodically updated. For example, new data may be added into the database (not shown in FIG. 1A) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to architecture in FIG. 1B, steps in flow diagram of FIG. 2.

FIGS. 2A through 2B (collectively referred as FIG. 2) is a flow diagram illustrating a method 200 for automated creation of tiny Deep Learning (DL) models based on the multi-objective reward function (R), using the system of FIG. 1A, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIG. 1A, 1B and the steps of flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

Referring to the steps of the method 200, at step 202 of the method 200, the one or more hardware processors 104 to receive a plurality of hardware specification parameters defining a plurality of performance metrics with relative metric weightages for creating a tiny model to be deployed on a platform having a set of hardware constraints. The plurality of performance metrics include an accuracy, a latency, a runtime memory usage, and a size of the tiny model and the like. The system 100 is configured to enable user to enter hardware specification details and weightages in a uniform description language.

Once the relative weightages are received, at step 204 of the method 200, the one or more hardware processors 104 are configured to formulate the multi-objective reward function (R) as an exponential function of the performance metrics. Each the plurality of performance metrics is individually modulated, prioritized and thresholded based on relative weightage assigned to each of the performance metric in accordance requirements of a target application to be executed on the platform via the tiny model. The multi-objective reward function (R) is updated by profiling the platform repeatedly to acquire the plurality of performance metric. The weighted relation of the multi-objective reward function with the accuracy is linear, and the latency, the runtime memory and the size is exponential, are added as a combined weighted exponential function of a difference between an actual values and a target values based on the hardware constraints for each of the latency, the runtime memory, and the size among the plurality of performance metrics.

The multi-objective reward function (R) is mathematically expressed as:

$$R = \frac{{W}_{a} Acc + {\sum }_{i} {W}_{i} {e}^{{P}_{i}}}{\sum W} \qquad ( 1 )$$

wherein Pᵢ is the i^{th} performance metric other than the accuracy (Acc), Pᵢ=Aᵢ−Tᵢ, Wᵢ is Weight of i^{th} metric, Wₐ is weight of accuracy (Acc), ΣW is the sum of all weights, Aᵢ and Tᵢ are actual values and target values of the performance metrics other than the accuracy (Acc), provided by the hardware constraints of the platform. Metrics such as accuracy, model size and peak memory load can be estimated on the SDK side, that is on the PC where the search is running. However, how much time is taken for inference, indicated by the latency, cannot be estimated in a trivial way and it is required to rub the generated model on the actual hardware. Thus, the method enables estimation of latency by providing a way to predict the latency. The actual latency performance metric required by the multi-objective reward function (R) can be predicted using a prediction function (P), without actually profiling the Neural Network (NN) architectures on a platform to make a NAS search faster. The prediction function (P) is explained later in conjunction with derivation of latency prediction function and expressed in equation6 below.

Once the multi-objective reward function (R), also interchangeably referred to as reward, is formulated in accordance with the relative weightages are received, at step 206 of the method 200, the one or more hardware processors 104 are configured to create a Neural Architecture Search (NAS) space (S^{O×C}) comprising of a plurality of operations and configurations of Neural Network (NN) architectures in accordance with the target application, as depicted in FIG. 1B.

At step 208 of the method 200, the one or more hardware processors 104 are configured to apply a coarse-grained search using a Fast Evolutionary Algorithm (EA) NAS model 110A to find relevant operations and configurations from the plurality of operations and configurations that narrows the NAS space to a refined NAS space (S′^{O′×C′}). The refined NAS space identifies a set of Neural Network (NN) architectures from the NAS space that performs better than a reward threshold. Based on the target device's resource budget (compute power, SRAM size and storage memory), we set some threshold values that limits which ML models can be chosen for further evaluation. These thresholds result in a reward value as well called the reward threshold or threshold reward/fitness. So, models that exceed the reward threshold are subjected to selection/evaluation. The EA agent of the FAST EA NAS model generates a plurality of child Neural Network (NN) architectures for the fine-grained NAS space from the NAS space based on the multi-objective reward function (R). Since traditionally EA is a non-learning approach, approach like RL is added to the traditional EA by incorporating domain knowledge as “learnable mutations” by the EA agent, in the evolution process. The agent decides upon the sequence of the child thus guaranteeing a better model. The multi-objective fitness function reduces the exploration of the Fast EA NAS model 110A and leads to better exploitations. The Fast EA NAS model 110A tries out and selects the most promising architecture from alternatives (NAS space) and acts as a pre-processor to reduce NAS search space for the next DQN NAS model performing the search.

Search strategy of the Fast EA NAS model 110A: Evolutionary search in NAS is usually preferred over many other search techniques like Random Search (RS) or even Bayesian Optimization (BO) because it is fast and finds solutions that are superior to other search techniques. This is because EA NAS considers a global aggregate of solutions rather than a subgroup. A variety of search techniques exist in EA NAS, but one that is preferred is the Aging Evolutionary Search in the literature. An initial population of randomly generated models is created and then from a random subset of models, the fittest model is selected for evolution, i.e., its architecture is randomly altered. This can be as simple as adding/removing a layer to changing the number of filters/units in a layer. The term “fitness” is used to describe the viability of a model to be chosen for evolution because is necessary find a model that satisfies multiple criteria. For those reasons, the best model is not found at this EA NAS stage (which would be true if there was a single objective) but a set of models called the Pareto-optimal set is identified. A further development is carried on work in the literature Edgar Liberis, Lukasz Dudziak and Nicholas D. Lane. (2020). μNAS: Constrained Neural Architecture

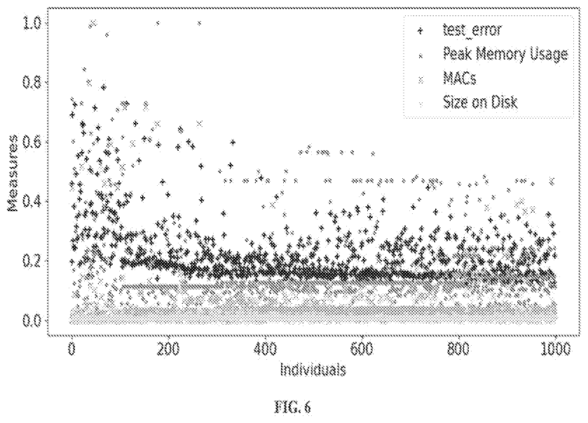

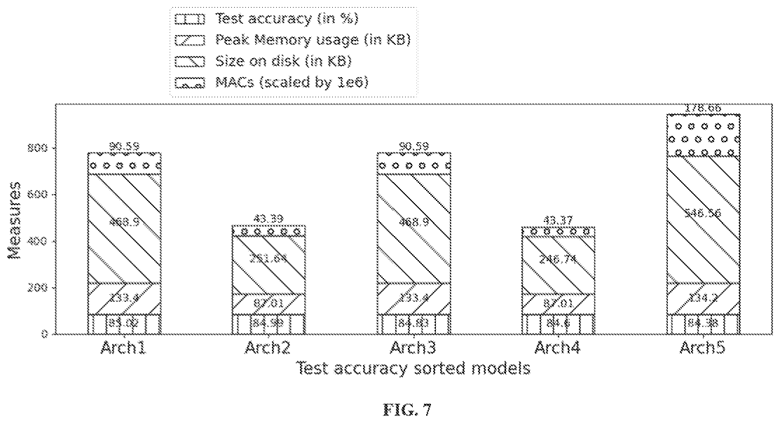

Search for Microcontrollers. for hardware modeling and searching targeting architecture for resource constrained devices. Even with a fast and sophisticated variant of Evolutionary search algorithm, a vast amount of time to search for models which are optimal in defined target objectives is looked into. This is because models attempting complex tasks need longer training time. A Progressive Dynamic Hurdles known in the literature is used to limit epochs allotted for each models based on a hurdle generated at different stages. This limits training time given to models showing no promise of being a viable candidate and allots extra time to those which shows that promise. The Fast EA NAS model was run for search on the CIFAR-10 dataset for a 1000 cycles, represented in FIG. 6. From the top 5 models based on test accuracy, represented by FIG. 7, the 2nd model and 4th model (K architectures) that cross the reward threshold are selected. As Decision Makers (DMs), users are allowed to provide preference to certain objectives such as the accuracy, latency, size, the runtime memory usage. For example, herein it is test accuracy.

At step 210 of the method 200, the one or more hardware processors 104 are configured to performing a fine-grained search on the refined NAS space to identify a customized and optimized architecture for the tiny model as depicted in FIG. 1B. The fine-grained search utilizes the DQN NAS model 110B, wherein a DQN agent of the DQN NAS model 110B utilizes the multi-objective reward function (R) to identify the customized and optimized architecture for the tiny model.

Search strategy of for DQN or RL based NAS approach used by the DQN NAS model 1108 is provided below:
a) Define Q Learning Neural Network
   a. 1 step=selection of 1 layer, 1 episode=1 complete model
b) Create new environment, Initialize parameters: no. of episodes E, Exploration rate c, Exploration decay c_decay, Discount rate γ, Batch size, Training samples
c) Generate action space by encoding possible layers and possible parameters into tuple format
d) For episode e in E, reset state space, check c value to select exploration or exploitation phase
e) Perform Exploration: 1. Random selection of layer type and layer parameters, 2. Continue selecting and adding layer to model until the termination layer is reached. 3. Evaluation of model and storing accuracy in memory as reward
f) Remember: 1. State-action pairs are stored in memory
g) Replay: 1. Q-values are evaluated in batches. 2. State values and
h) Fit Q-values into the DQN model
i) Exploitation: 1. Current state is taken as input to DQN model, action (layer selection) is predicted by QNN model. 2. All layers are combined into model, and accuracy is evaluated.

The relative weightage assigned to each of the performance metric is tunable, enabling dynamic changing of the multi-objective reward function (R) without requiring rebuilding and retraining of the Fast Evolutionary Algorithm (EA) NAS model and the DQN NAS model to align to changing requirements of the target application to be executed on the platform.

DQN learning based NAS: The neural architecture search algorithm based on reinforcement learning attempts to design high performance neural network architectures automatically. This is done with the help of an agent, by the process of exploring new architecture designs, evaluating them in terms of accuracy and model size, and then training the agent with those sets of states, actions, and rewards. The learning mechanism for the agent is through Deep Q-Learning technique, which is a type of reinforcement learning. The goal is to sequentially choose Neural Network layers using Q-learning and the epsilon-greedy strategy of exploration followed by experience replay. The Deep Q Learning agent explores the space of possible architectures and generates new configurations with improved performance on the selected dataset. The method 200 disclosed herein relies on Q-learning, a type of reinforcement learning.

RL Environment Design for NAS: The Reinforcement Learning Environment for generating and selecting Neural Network Architectures is designed in such a way as to specify the various states and actions permissible for the DQN agent. The environment also specifies the way it behaves when an action is performed at a given state, and thus the resulting next state evaluation. The state variables and action constraints are defined in the RL environment. The environment consists of the functions “explore action”, “step execution”, “reward calculation” and the state and action space specification parameters such as the kernel size, number of filters, number of neurons for dense layer, stride, etc. The details of the Agent and Exploration space are stated in the following subsection.

RL Agent (DQN agent) and Exploration Space: The RL agent is responsible for exploring the environment and performing various actions to collect rewards. The goal is to maximize the accumulated reward, which in the NAS Environment is a combination of accuracy, model size, latency, memory, and various other parameters, with varying weights as per application requirements. The functions of the agent include “run”, “act”, “remember” and “replay” which portray the behavior of the agent under different environment conditions, based on the reward received on performing various actions. In the process of neural architecture design, the sequential selection of layers is viewed as a Markov Decision Process where the selection of each layer is the action taken by the agent and the states are comprised of the outcome of selected action. The action space includes the different kinds of layers such as Convolution, Max Pooling, Dense and Termination (SoftMax) layers, with a range of parameters such as layer depth, Kernel Size, number of filters, stride, number of neurons to allow the agent to try various combinations of these parameters and come up with the best designs. A number of layers selected sequentially form a complete episode, at the end of which the accuracy and model size are evaluated to formulate the reward.

The Deep Q-Learning Network (DQN) agent is a Deep Neural Network having 4 dense layers with input dimension same as that of current state and output dimension equivalent to the size of the action space. The exploration strategy is based on epsilon greedy algorithm, where the epsilon value determines the exploration rate, and the value is set to 1.0 at the beginning of the Reinforcement Learning process, and on completion of a specified number of training episodes, it is decreased by a factor of 0.999 with each subsequent episode. The value of epsilon determines the probability of exploration and when this value reduces, the learned values from the DQN agent prior experience are looked up and for a given state, the action corresponding to the highest Q-value is selected. The expression for optimal Q-value is as follows:

Q*(s,a)=R(s,a)+γmax′a[Q*(s′,a′)] (2)

Here, Q*(s, a) is the optimal Q-value of current state, Q*(s′, a′) is the optimal Q−value for next state, R(s, a) is the reward for current state given the action a is performed. γ is the discount factor which defines the weights of future rewards over immediate rewards. The expression max′a denotes the best action chosen to ensure highest Q−value in the next steps. For the implementation of the Neural Architecture Search algorithm with Reinforcement Learning, the states, actions, and models are represented in the form of tuples. The actions are represented by numeric values which signify the various parameters of the layers such as kernel size, number of filters, stride, number of neurons, to specify the exact configuration of the Neural Network Layer. Experiments have been conducted considering the various layers that constitute a Convolutional Neural Network, but the algorithm can be tuned to other types of neural networks as well, with variations needed in the state space definition and the action constraints.

Knowledge-guided Deep Q-Learning Neural Architecture Search of the DQN NAS model 1108: In addition to the accuracy and model size being determining factors for reward formulation, knowledge of hardware based specifications and constraints also play a major role in reshaping the rewards. Hardware based knowledge includes processor speed, available memory, and availability of accelerators to expedite specific instructions, which result in the generation of more efficient network designs. Additional reward parameters such as latency and floating point operations are directly linked to the hardware configuration.
Formulation of Rewards: As discussed above, there are different factors contributing to the reward formulation as depicted in equation 1

$$R = \frac{{W}_{a} Acc + {\sum }_{i} {W}_{i} {e}^{{P}_{i}}}{\sum W}$$

where

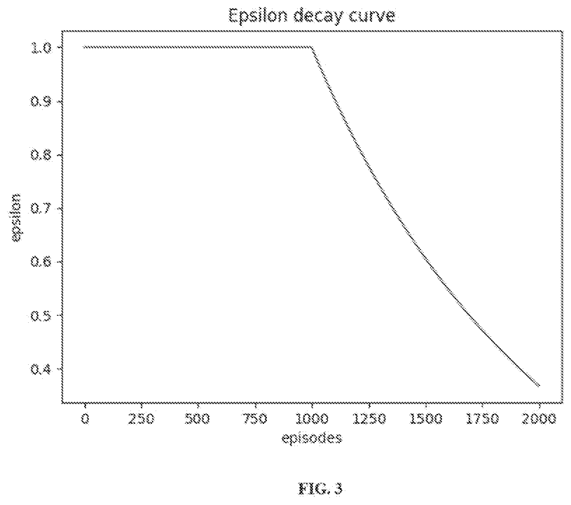

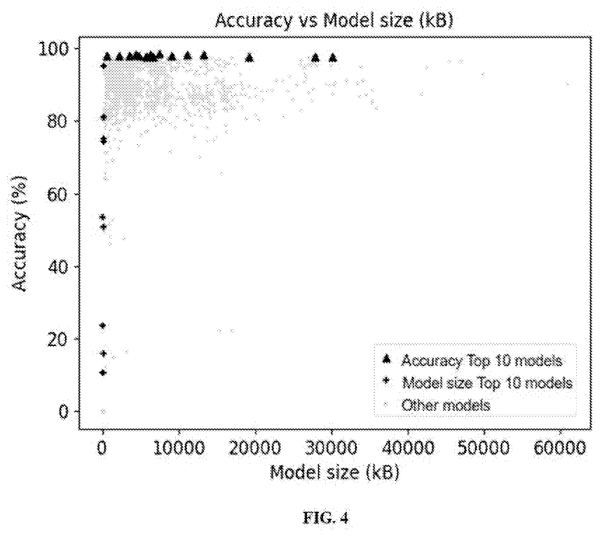

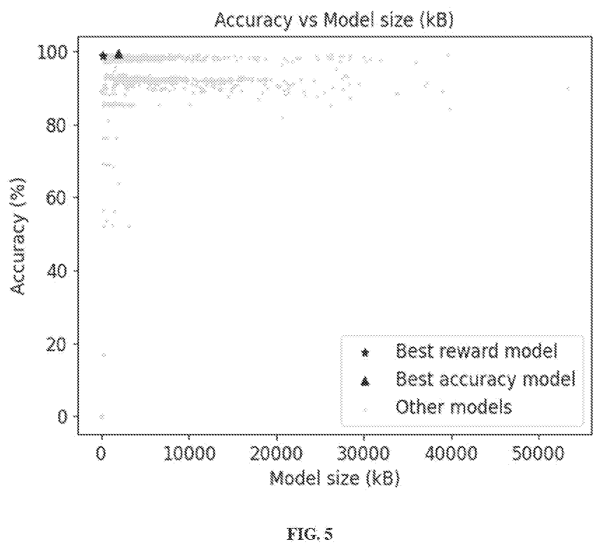

Results: Experiments were conducted on small datasets to observe the performance of the Deep Q-Learning NAS model 110 while creating tiny DL models and results depicted in FIGS. 3 through 5. with the MNIST image dataset, where 2000 models are generated. FIGS. 4 and 5 depict the accuracy versus model size scatter plot with 2000 generated models, and the best performing models in terms of Overall Reward (Exponential Expression), Accuracy, and model size have been shown, highlighted by separate symbols. The reward function here, helps generate the best models as per accuracy and size requirement of the desired application.

The highest accuracy value obtained is 100% during exploration phase with a 4-label image dataset. When considering model size as a parameter for evaluating reward, for the experiment of a total of 100 episodes, the model that satisfies both the accuracy and size constraints showed an output of Accuracy=99.82% and Model size=315.056 kB. The results are depicted in the FIGS. 3, and 4. FIG. 5 depicts the results for full MNIST datasets with 10 output classes. The best reward model accumulates a total reward=950.27, accuracy=95.33%, model size=102.73 kB (depicted in red), when equal weights are given for both the parameters accuracy and size in reward formulation, whereas the best accuracy model gets a total reward=449.35, accuracy=99.19%, model size=226.04 kB (depicted in black) with a total of 700 episodes.

Neural Surrogates with NAS: The platform aware NAS has a very challenging problem when it attempts to include embedded devices for the sampling new architecture. There is no other alternative other than running a new architecture in a given embedded hardware to find the execution latency, power consumption and other hardware dependent metrics. For instance, given P layer-wise configurations, a model with L layers and C different choices or those techniques, the total number of combinations to compute comes to be P×C×L. With a minimum T time needed to run a test cycle in a target dataset, the number of combinations explode. A technique is required to find the metrics associated with hardware execution without actually executing the neural network.

Need for Prediction: Predicted execution time for Deep Neural Network (DNN) guides the decision for selecting optimal model on edge device, e.g., Network Architecture Search (NAS) algorithm and DNN acceleration algorithm from the literature. Simple heuristic-based models are popular for predicting execution time. Number of FLOPs is usually used as a proxy for neural network latency. Thus, number of parameters and total FLOPs are used as estimator of execution time. Such prediction model does not lead to good estimate of execution time e.g., the fully connected layer usually has more parameters but takes much less time to run compared

to the convolution Layer. Non-linear relation between network structure and execution
time is explained in one of the literature works. Moreover, there are effect of caching, memory access, inter-process communication and compiler optimization. Good estimator of execution time improves the efficiency of NAS and acceleration algorithms. Number of parameters and total FLOPs-based prediction model may complicate the decision of such algorithms. Let us consider, two models have same total FLOPs in which number of multiplication of two model are different. Heuristic-based prediction infers same latency for both models, though the latency is not same. Why Execution times for different types of operation (addition, multiplication, division, max, min etc.) are different. To break the tie, it needs more fine-grained prediction model. Thus, there are following objectives:
Consider different types of FLOP instead of compound FLOP like MAC.
Consider device configuration (caching, memory access, inter-process communication) to determine execution times for different types of FLOP.
Predict layer-wise and model-wise execution time of CNN

Evaluation of the latency prediction mechanism based on the structural and embedded system parameters:

### Hardware Model:

1. Layer-wise Latency: Convolution Layer
Input tensor=I_{X}×I_{Y}×I_{C}
Output tensor=O_{X}×O_{Y}×O_{C}
Filters=F_{X}×F_{Y}×I_{C}×O_{C}
Stride=S, Padding=P
No. of Multiplications=F_{X}*F_{Y}*(└(I_{X}−F_{X}+2P)┘+1)*(└(I_{Y}−F_{Y}+2P)/S┘+1)*I_{C}*O_{C}=F_{X}*F_{Y}*O_{X}*O_{Y}*I_{C}*O_{C}=N_{M}
No. of Additions=└(F_{X}*F_{Y}−1)*I_{C}+(I_{C}−1)┘*O_{X}*O_{Y}*O_{C}=N_{A}
Execution time=T_{M}*N_{M}+T_{A}*N_{A}+βi
where, T_{M}=Time for multiplication (Platform dependent), T_{A}=Time for addition (Platform dependent) and βi=Memory overhead (Platform dependent)
2. Layer-wise Latency: Pooling and Fully Connected Layer
(MAX) Pooling Layer:
Input Tensor=I_{X}×I_{Y}×I_{C}
Tile=F_{X}×F_{Y}×I_{C}, Stride=S, Padding=P
Comparison=F_{X}*F_{Y}*(└(I_{X}−F_{X}+2P)/S┘+1)*(└(I_{Y}−F_{Y}+2P)/S┘+1)*I_{C}=N_{C}
Latency=T_{C}*N_{C}
where, T_{C}=Time for floating point comparison
Fully Connected Layer:
Input Tensor=1×I_{Y}
Filter=F_{X}×F_{Y}[I_{Y}=F+X]
Multiplication=I_{Y}*F_{X}*F_{Y}=N_{M}
Addition=(I_{Y}*F_{X}−1)*F_{Y}=N_{A}
Latency=T_{M}*N_{M}+T_{A}*N_{A}+βi
3. Layer-wise Latency: Depth-wise and Point-wise Convolution Layer
Depth-wise Convolution Layer:
Input Tensor=I_{X}×I_{Y}×I_{C}
Output Tensor=O_{X}×O_{Y}×O_{C}
Filter=F_{X}×F_{Y}×I_{C}×O_{C}
Stride=S, Padding=P
No. of Multiplications=F_{X}*F_{Y}*O_{X}*O_{Y}*I_{C}
No. of Additions=(F_{X}*F_{Y}−1)*O_{X}*O_{Y}*I_{C}
Point-wise Convolution Layer:
No. of Multiplications=I_{C}*O_{X}*O_{Y}*O_{C}
No. of Additions=(I_{C}−1)*O_{X}*O_{Y}*O_{C}
4. Platform Dependent Parameters
Parameters list
Execution time for basic operations=T_{O}
Access time for cache (consider multi-level cache)=T_{C}
Read+write time of primary memory=T_{R(RAM)}+T_{W(RAM)}
Read+write time of secondary memory=T_{R(ROM)}+T_{W(ROM)}
Effective Time
For single-level cache:
If Cache hit, Effective time=T_{O}+T_{C}
If Cache miss, Effective time=T_{O}+2T_{C}+T_{R(RAM)}+T_{W(RAM)}
   The Latency Prediction approach through the above discussed parameters is disclosed by the method disclosed herein. Thus, the latency performance metric required by the multi-objective reward function (R) can be predicted using a prediction function (P), without actually profiling the Neural Network (NN) architectures on a platform to make a NAS search faster. and is expressed as follows:
Execution time for convolution layer=T_{M}*T_{N}+T_{A}*N_{A}

Effective Execution Time=P=ET_{M}*N_{M}+ET_{A}*N_{A}+βi (3)
where ET_{M}, ET_{A} are Effective Execution Time for multiplication and addition respectively.

### Prediction of Effective Latency:

If m is cache miss ratio, latency/FLOP

(1−m)(T_{O}+T_{C})+m(T_{O}+2T_{C}+T_{R(RAM)}+T_{W(RAM)}=T_{O}+(1−m)T_{C}+m(2T_{C}+T_{R(RAM)}+T_{W(RAM)}) (4)
Therefore, layer wise latency

T(lₗ)=Σ_{j∈0}NⱼTⱼ+Σ_{j∈0}Nⱼ(1−m)T_{c}+Σ_{j∈0}Nⱼm m(2T_{C}+T_{R(RAM)}+T_{W(RAM)}) (5)
Inference Latency of NN

$$T ( NN ) = {\sum }_{i} {Size}_{{of}_{{WM}_{i}}} ( {T}_{R ( ROM )} + {T}_{W ( RAM )} ) + {\sum }_{i} T ( {l}_{l} ) \qquad ( 6 )$$

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

Thus, the method and system disclosed herein takes model accuracy, system constraints and the like and system utilization all together in a NAS framework. Further, utilizes the multi-objective reward function formulated for NAS with Accuracy, Latency, Runtime Memory, and Size to find the optimum model in an automated manner. The system allows user to enter hardware details in a uniform description language for NAS.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for automated creation of tiny Deep Learning (DL) models, the method comprising:
receiving, via one or more hardware processors, a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model;
formulating, via the one or more hardware processors, a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics;
creating, via the one or more hardware processors, a Neural Architecture Search (NAS) space (S^{O×C}) comprising of a plurality of operations and configurations of Neural Network (NN) architectures in accordance with the target application;
applying, via the one or more hardware processors, a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R); and
performing, via the one or more hardware processors, a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model.

2. The method of claim 1, wherein a weighted relation of the multi-objective reward function (R) with the accuracy is linear, and the latency, the runtime memory and the size are exponential are added as a combined weighted exponential function of a difference between one or more actual values and one or more target values based on the hardware constraints for each of the latency, the runtime memory, and the size among the plurality of performance metrics.

3. The method of claim 2, wherein the multi-objective reward function (R) is mathematically expressed as
$$R = \frac{{W}_{a} Acc + {\sum }_{i} {W}_{i} {e}^{{P}_{i}}}{\sum W} ,$$
wherein Pᵢ is the i^{th} performance metric excluding the accuracy (Acc), Pᵢ=Aᵢ−Tᵢ, Wᵢ is weight of i^{th} metric, Wₐ is weight of accuracy (Acc), ΣW is the sum of all weights, Aᵢ and Tᵢ are actual values and target values of the performance metrics except the accuracy (Acc), provided by the hardware constraints of the platform.

4. The method of claim 1, wherein an actual latency performance metric required by the multi-objective reward function (R) is predicted using a prediction function (P), without actually profiling the Neural Network (NN) architectures on a platform to enable faster NAS search.

5. The method of claim 4, wherein the prediction function (P) is mathematically expressed as P=ET_{M}*N_{M}+ET_{A}*N_{A}+βi, wherein ET_{M} and ET_{A} indicate a platform dependent effective execution time for multiplication and addition respectively, and βᵢ is a platform dependent memory overhead.

6. The method of claim 1, wherein the relative metric weightages assigned to each of the performance metric are tunable, enabling dynamic changing of the multi-objective reward function (R) without requiring rebuilding and retraining of the Fast Evolutionary Algorithm (EA) NAS and the DQN architecture to align to changing requirements of the target application to be executed on the platform.

7. A system for automated creation of tiny Deep Learning (DL) models, the system comprising:
a memory storing instructions;
one or more Input/Output (I/O) interfaces; and
one or more hardware processors coupled to the memory via the one or more I/O interfaces, wherein the one or more hardware processors
(104) are configured by the instructions to:
receive a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model;
formulate a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics;
create a Neural Architecture Search (NAS) space (S^{O×C}) comprising of a plurality of operations and configurations of Neural Network (NN) architectures in accordance with the target application;
apply a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R); and
perform a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model.

8. The system of claim 7, wherein a weighted relation of the multi-objective reward function (R) with the accuracy is linear, and the latency, the runtime memory and the size are exponential are added as a combined weighted exponential function of a difference between one or more actual values and one or more target values based on the hardware constraints for each of the latency, the runtime memory, and the size among the plurality of performance metrics.

9. The system of claim 8, wherein the multi-objective reward function (R) is mathematically expressed as
$$R = \frac{{W}_{a} Acc + {\sum }_{i} {W}_{i} {e}^{{P}_{i}}}{\sum W} ,$$
wherein Pᵢ is the i^{th} performance metric excluding the accuracy (Acc), Pᵢ=Aᵢ−Tᵢ, Wᵢ is weight of i^{th} metric, Wₐ is weight of accuracy (Acc), ΣW is the sum of all weights, Aᵢ and Tᵢ are actual values and target values of the performance metrics except the accuracy (Acc), provided by the hardware constraints of the platform.

10. The system of claim 7, wherein an actual latency performance metric required by the multi-objective reward function (R) is predicted using a prediction function (P), without actually profiling the Neural Network (NN) architectures on a platform to enable faster NAS search.

11. The system of claim 10, wherein the prediction function (P) is mathematically expressed as P=ET_{M}*N_{M}+ET_{A}*N_{A}+βᵢ, wherein ET_{M} and ET_{A} indicate a platform dependent effective execution time for multiplication and addition respectively, N_{M} and N_{A} are number of multiplications and additions respectively, and βᵢ is a platform dependent memory overhead.

12. The system of claim 7, wherein the relative metric weightages assigned to each of the performance metric are tunable, enabling dynamic changing of the multi-objective reward function (R) without requiring rebuilding and retraining of the Fast Evolutionary Algorithm (EA) NAS and the DQN architecture to align to changing requirements of the target application to be executed on the platform.

13. One or more non-transitory machine-readable information storage mediums comprising one or more instructions which when executed by one or more hardware processors cause:
receiving, a plurality of hardware specification parameters, defining a plurality of performance metrics with relative metric weightages for creating a tiny model to be deployed on a platform having a set of hardware constraints, the plurality of performance metrics comprising an accuracy, a latency, a runtime memory usage, and a size of the tiny model;
formulating, a multi-objective reward function (R) as a function of the plurality of performance metrics, wherein each of the plurality of performance metrics is individually modulated, prioritized and thresholded based on the relative metric weightage assigned to each of the plurality of performance metric in accordance of requirements of a target application to be executed on the platform via the tiny model, and wherein the multi-objective reward function (R) is updated by iteratively profiling the platform to acquire the plurality of performance metrics;
creating, a Neural Architecture Search (NAS) space (S^{O×C}) comprising of a plurality of operations and configurations of Neural Network (NN) architectures in accordance with the target application;
applying, a coarse-grained search on the NAS space using a Fast Evolutionary Algorithm (EA) NAS model to find relevant operations and configurations from the plurality of operations and configurations that narrows the NAS space to a refined NAS space (S′^{O′×C′}) by identifying a set of Neural Network (NN) architectures from the NAS space that performs better than a reward threshold, wherein an EA agent of the FAST EA NAS model generates a plurality of child Neural Network (NN) architectures for the fine-grained NAS space from the NAS space based on the multi-objective reward function (R); and
performing, a fine-grained search on the refined NAS space to identify a customized and optimized architecture for the tiny model, wherein the fine-grained search utilizes a Deep Q-Learning Network (DQN) NAS model, and wherein a DQN agent of the DQN NAS model utilizes the multi-objective reward function (R) to identify the customized and optimized architecture for the tiny model.

14. The one or more non-transitory machine-readable information storage mediums of claim 13, wherein a weighted relation of the multi-objective reward function (R) with the accuracy is linear, and the latency, the runtime memory and the size are exponential are added as a combined weighted exponential function of a difference between one or more actual values and one or more target values based on the hardware constraints for each of the latency, the runtime memory, and the size among the plurality of performance metrics.

15. The one or more non-transitory machine-readable information storage mediums of claim 14, wherein the multi-objective reward function (R) is mathematically expressed as
$$R = \frac{{W}_{a} Acc + {\sum }_{i} {W}_{i} {e}^{{P}_{i}}}{\sum W} ,$$
wherein Pᵢ is the i^{th} performance metric excluding the accuracy (Acc), Pᵢ=Aᵢ−Tᵢ, Wᵢ is weight of i^{th} metric, Wₐ is weight of accuracy (Acc), ΣW is the sum of all weights, Aᵢ and Tᵢ are actual values and target values of the performance metrics except the accuracy (Acc), provided by the hardware constraints of the platform.

16. The one or more non-transitory machine-readable information storage mediums of claim 13, wherein an actual latency performance metric required by the multi-objective reward function (R) is predicted using a prediction function (P), without actually profiling the Neural Network (NN) architectures on a platform to enable faster NAS search.

17. The one or more non-transitory machine-readable information storage mediums of claim 16, wherein the prediction function (P) is mathematically expressed as P=ET_{M}*N_{M}+ET_{A}*N_{A}+βᵢ, wherein ET_{M} and ET_{A} indicate a platform dependent effective execution time for multiplication and addition respectively, and βᵢ is a platform dependent memory overhead.

18. The one or more non-transitory machine-readable information storage mediums of claim 13, wherein the relative metric weightages assigned to each of the performance metric are tunable, enabling dynamic changing of the multi-objective reward function (R) without requiring rebuilding and retraining of the Fast Evolutionary Algorithm (EA) NAS and the DQN architecture to align to changing requirements of the target application to be executed on the platform.
